(19) United States
(12) Patent Application Publication
(10) Pub. No.: US 2011/0104962 A1
(43) Pub. Date: May 5, 2011

(54) VEHICLE CONTROL DEVICE

(75) Inventors: Christian Krause, Guetersloh (DE); Hans-Joachim Herbermann, Paderborn (DE)

(73) Assignee: FISCHER PANDA GMBH, Paderborn (DE)

(21) Appl. No.: 12/894,321

(22) Filed: Sep. 30, 2010

(30) Foreign Application Priority Data
Nov. 4, 2009 (DE) 20 2009 015 027.5

(51) Int. Cl. B63H 21/21; B60W 20/00; B60K 6/46; B60W 10/08; B60W 10/26; B63H 21/17

(52) U.S. Cl. 440/2; 701/22; 180/65.245; 903/930

(57) ABSTRACT

A device for controlling a vehicle, in particular a watercraft with a drive system with an energy generating device including a combustion engine, an electric generator adapted to coact with said combustion engine, and a rectifier for rectifying the electrical energy; an energy storage device to store the electrical energy for energy output as and how required; and an energy distribution system for distributing the energy made available by the energy generating and/or the energy storage device to at least one electric motor used to drive a propeller, as well as to other electric power consumers. A central control unit is data-technically coupled with the energy generating device, the energy storage device and the energy distribution system to coordinate energy generation, storage and distribution. The central control device has output means for display of information to a user and/or input means (19) for entry of signals by a user.

This present invention relates to a device for controlling a vehicle, in particular a watercraft, wherein the vehicle has a drive system which comprises an energy generating device with a combustion engine, a generator adapted to coact with said combustion engine for converting the mechanical energy produced inside said engine into electrical energy and a rectifier for rectifying the energy made available by said generator, which comprises an energy storage device with an energy storage unit to store the energy made available by the generator for energy output as and how required, and which comprises an energy distribution system for distributing the energy made available by the energy generating and/or the energy storage device to at least one electric motor used to drive a propeller as well as to other electric power consumers.

A commercial type Diesel-electric drive system for ships and other maritime objects substantially comprises a Diesel engine, a generator driven by said engine to generate electrical energy and an electric motor which is driven via a motor control unit (converter) and which operates a propeller (ship's screw) by means of energy made available by the generator. Hybrid drive systems also are known in which an energy storage device for storing electric energy is assigned to the generator. In that case is the energy for driving the electric motor made available by the generator direct and/or by the energy storage device which latter also serves to supply energy to the on-board electric system. Drive systems of that type are increasingly being used as main and auxiliary drives for watercrafts, for instance ships. Other than in the case of conventional drives, for instance those of Diesel-mechanical type, this permits to waive any rigid coupling of the combustion engine with the propeller via drive shaft. The electric motor which is typically arranged in direct vicinity of the propeller is rather electrically connected to the generator and/or energy storage device. This affords essentially greater geometrical freedom for arrangement of equipment units. Moreover, it is possible to drive and navigate the watercraft with a very high degree of sensitiveness and precision over a vast speed range. It is even possible to do without a separate rudder for directional steering and instead to swing the propeller connected to the electric motor. To this end, the electric motor is for instance an underwater motor arranged inside a gondola that is in swinging connection with the vehicle. What affects such particularly favourable cruising and navigating properties, however, is that essential functional components of the drive system such as in particular the generator, the converter and the energy storage device are separated as far as the control thereof is concerned. There is no communication existing between generator, energy storage device, converter and/or electric motor in today's low-price drive systems. Separate indicating and operating elements are instead provided for Diesel generator, battery control unit and motor control units. It is hence up to the user to tune the operational performance of such different components and to ensure faultless coaction thereof by active intervention on his own. Nonetheless has a drive system many latent sources of faults which an inexperienced user may not or not early enough recognize. In case of generator failure, for instance, the energy storage device is no longer being charged. If an electric consumer is not cut out in such a case, exhaustive discharge of the energy storage device may be caused with the consequence that safety-critical drive and navigating functions of the watercraft cannot be kept up.

It is an object of this present invention, therefore, to provide a well-priced drive system for vehicles, in particularly watercrafts, that is featuring a high degree of operational safety and minimum susceptibility to failure.

To achieve this object the invention is in conjunction with the preamble of Patent Claim 1 characterized by the fact that a centrali control device with a central control unit is provided in which the latter is data-technically coupled with the energy generating device, the energy storage device and the energy distribution system to coordinate energy generation, energy storage and energy distribution, and that the central control device is provided with output means for display of information to the user and/or input means for entry of signals by the user.

The particular advantage of this invention is that due to data-technical coupling of an energy generating device, an energy storage device and an energy distribution system with a central control device it is possible to achieve data-technical networking of the three main components of the drive system. This affords completely new approaches for early error detection on the one hand and for monitoring the condition of the main components with the operating parameters of the energy generating device, the energy storage device and the energy distribution system transferred to the central control unit and stored and/or processed there. Such central data acquisition and processing enables all of the main components to react to an error affecting just one functional component in a predetermined performance scheme without any need for a user to intervene manually. Errors due to human failure can be effectively avoided this way. In case of generator failure and discharge of the energy storage device to below a critical limit, for instance, all electrical functions which are not really vital aboard the vehicle will be deactivated. The energy available is in that case exclusively used for feeding the electric motors so that a minimum of vehicle driving and navigating ability is preserved.

Providing a central control device with output and input means on the other hand permits to create a central guidance, operation and communication module which is for instance arranged inside a central casing and comprises a screen, a loudspeaker or signal lamps as output means and control elements, variable transformers or such like as input means. Moreover it is possible to provide as combined input and output means a touch screen adapted to display different input buttons as required and to have manual inputs made by a user.

In a preferred embodiment of this invention a data bus is provided for data-technical coupling of the central control unit with the energy generating device and/or the energy storage device and/or the energy distribution system. Provision of a bus connection affords an exceptionally simple and low-cost approach for networking the functional components of the drive system. The extent of mounting and installation in that case is much less than in case of individual point-to-point cabling of individual components to the central control unit. In addition, a hierarchical order may be simply established of the functional components as such, of data transfer and of signals and instructions transmitted by the various functional components of the drive system. Also, further electric consumers may be connected to the data bus. It is easy this way to monitor and/or control such consumers via the central control module.

The term “control” as used in this application will be understood to include regulating functions also. In particular, it is possible to implement a regulating function and/or regulating algorithm by means of the motor control device or a control module, respectively.

A modification of this present invention provides for the central control unit to be coupled with a decentralized control module of the energy generating device and/or a decentralized control module of the energy distribution device. This coupling permits to transfer non-local control parameters from the central control unit to at least one decentralized control module and/or local control parameters from at least one decentralized control module to the central control unit. Control parameters thus transmitted may for instance be setpoint values, actual values or regulating commands. This affords the advantage that influence may be taken on regulating functions or the functional behavior of a decentralized control module and that operating parameters from some other functional component may be accounted for. The cooling capacity of an electric motor driven coolant pump may be increased, for instance, when a temperature sensor indicates elevated temperature of the electric motor or the energy distribution device. The decentralized control module permits to achieve quick regulation of a respective functional component right on the spot. The overlaid central control unit coordinates various decentralized control modules and/or undertakes by itself the control of those functional components that have no separate decentralized control module. A modular hierarchic arrangement of the control system enables to build up a flexible drive system into which components of different brands may be integrated.

A further modification of this present invention provides for operating parameters of the energy generating device, the energy storage device, the energy distribution system, the electric motor and/or further consumers to be detected by at least one sensor. This at least one sensor is connected to the data bus via an analog or digital interface module such that operating parameters can be transmitted to the central control unit or a decentralized control module by said sensor. This affords the advantage that a plurality of critical functional components can be monitored with exceptional ease due to such bus supported transmission. Sensors may be readily added or exchanged since what it takes is solely a connection to the data bus and no sensor linking to a special control module or the central control unit. This way it becomes possible to achieve additional control, comfort and/or safety functions by subsequent software and/or hardware updating, for instance within the scope of maintenance activities.

Another modification of the invention provides for measuring means detecting an operating state of the energy distribution device to be arranged between the energy generating device and the energy storage device on the one hand and between the energy storage device and the energy distribution system on the other hand. Involved in this conjunction is a differential current and voltage measurement wherein the measuring means are connected to the central control unit and/or the decentralized control unit of the energy storage device. It is an advantage afforded by provision of said measuring means that a battery management function can be implemented by means of which the charge condition of the energy storage device as well as the charge and load current thereof can be monitored in a reliable and simple way. Since the operating state of the energy storage device is known it is possible to provide for additional safety and comfort functions. For instance can the generator be activated automatically whenever the charge condition of the energy storage device drops to below a predefined limit. It is imaginable also to deactivate individual electric consumers to which safety is not an essential factor and/or to throttle the performance thereof whenever the battery current reaches a predetermined peak value and/or the charge condition gets down to a critical level.

A still further modification of the invention provides for at least one electric facility and/or consumer to be connected to the energy supply system and powered therefrom. Assigned to that facility is also a control module which is via the data bus connected to the central control unit and/or to a decentralized control module through which said facility can be activated or deactivated. This advantageously offers the possibility to improve the energy management even further and to inhibit accidental discharge of the energy storage device. An electric consumer can hence be deactivated automatically after a preset operating time to make sure that said consumer will not remain activated unnoticed and unintended. It is possible also to deactivate less essential electric consumers completely and/or to reduce the performance thereof as and when the charge of the energy storage unit drops to below a predetermined level. Moreover, activation of defined electric consumers can be blocked if in case of a boat or vessel charter these have not been paid for or instructions of how to operate them have not yet been given.

In another modification of the invention the energy distribution system is provided with at least one frequency converter as decentralized control module for variable speed operation of the at least one electric motor and/or at least one further decentralized control module in the form of an inverter for inversion of the DC voltage made available by the energy generating device and/or energy storage device. The electric motor can be operated very sensitively and variably due to said variable speed operation of the electric motor by means of a frequency converter. The propulsion of the watercraft can be regulated very exactly and varied over a vast range this way. By provision of said inverter it is possible to adjust the electric energy made available by the energy generating and/or energy storage device to a given AC voltage such as 230 V for operation of the electric consumers that constitute the on-board electric system. The consumers in that case in the form of commercial type appliances like a coffee machine, a computer or an air compressor for filling compressed air cylinders may be connected to the ship's own electric system.

According to another modification of the invention an electric isolating transformer is assigned to the energy distribution system. This isolating transformer is arranged between the energy distribution system and a coupler element for electro-mechanical connection of the distribution system to a stationary electric system ashore. The energy distribution system comprises a converter which is in the form of a storage-charger unit and electrically connected to the coupler element via said isolating transformer for charging the energy storage device with land current. It is an advantage, therefore, that the energy storage device can be charged solely from a land power system rather than a Diesel engine operated generator. Particularly for smaller vehicles such as inland ships may a generator be omitted completely. The energy storage device will be charged with land current exclusively in that case. Since it is not possible to recharge the energy storage device during use of the vehicle it is absolutely necessary to provide for a superordinated battery management and monitoring of the restricted electric power source. The transformer ensures electric isolation of energy storage device and on-board electric system. The storage-charger unit may be a separate converter and/or an inverter used to connect the energy generating and/or the energy storage device to the ship's own power system.

In a further modification of the invention the central control unit is connected to the energy generating device and/or the energy distribution system via a first data bus and to the energy storage device and/or further electric consumers via a second data bus. Advantageously it is possible by provision of two separate bus systems to have a priorization of the functional components imaged on the hardware side also with high priority allocated to the energy generating device via the first data bus and lesser priority to the further consumers as well as the energy storage device via the second data bus.

Another modification of the invention provides for the central control unit to be coupled to a radio module for transmission of data from an external transmitter to the central control unit and/or from the central control unit to an external receiver. This affords the advantage that remote access to the control unit can be achieved such that software updates can be applied and/or software errors be eliminated almost immediately after they have been discovered. It is also possible to read external signals such as a GPS signal into the central control unit. It is upon receipt of that GPS signal that in connection with the drive system a so-called electric anchoring function may be implemented in which case no mechanical anchor is dropped and the ship is kept in a predetermined position through respective activation of the electric motors. By data transfer to an external receiver it is practicable on the one hand to transfer data to an external diagnosis unit and on the other hand to monitor online and in time such operating parameters, for instance of charter or shipping companies, that may be used for accounting services, for instance in terms of cruising distances or type of use. Also, the position of the vessel may be externally monitored this way.

Exemplary embodiments of this present invention will now be described in closer detail with reference to the accompanying drawings.

In this drawings:

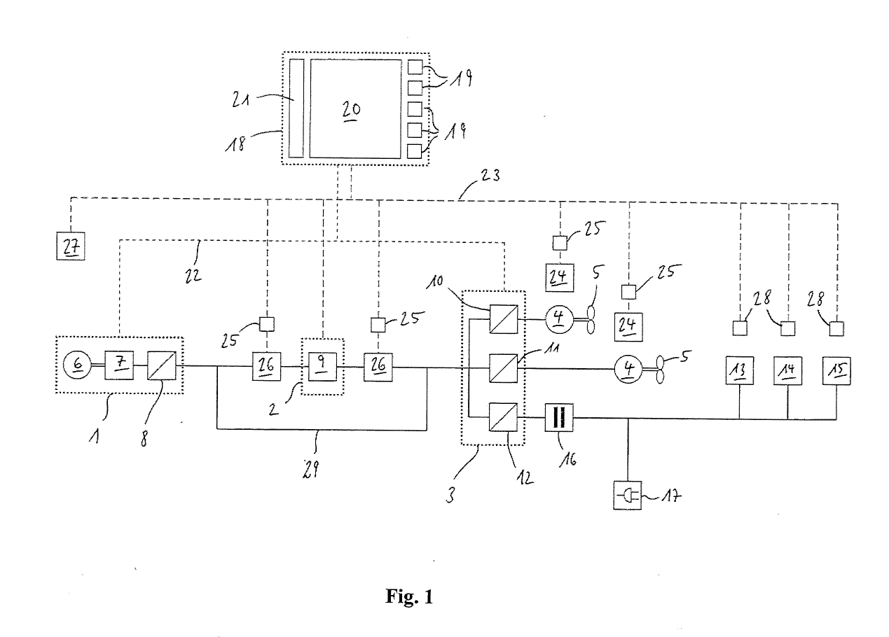

FIG. 1 shows a first configuration of a drive system and

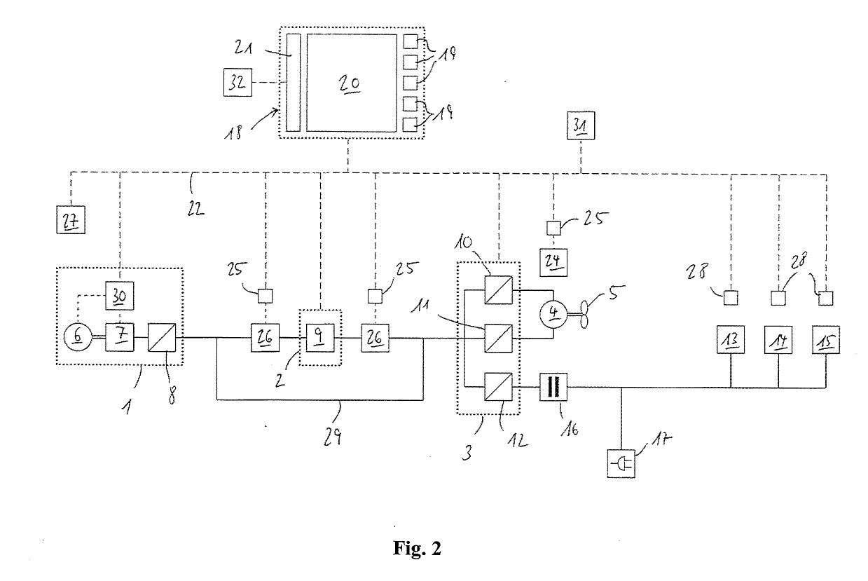

FIG. 2 represents a second configuration of a drive.

A drive system according to FIG. 1 serves for driving and/or navigating a vehicle, in particular a watercraft. The drive system substantially consists of an energy generating device 1, an energy storage device 2, an energy distribution system 3 and two electric motors 4 for driving a propeller 5.

The energy generating device 1 comprises a generator 7 powered by a Diesel engine 6 to generate electric energy which is rectified in a downstream rectifier 8 and passed to an energy storage unit 9 of the energy storage device 2 and/or via a bypass 29 to the energy distribution system 3 direct.

In an alternative embodiment of the invention it is possible to omit the energy storage unit 9 in which case the energy distribution system 4 is direct coupled to the energy storage device 3.

The energy distribution system 3 comprises two decentralized control modules 10, 11 to drive the electric motors 4, i.e. each of these modules 10, 11 to drive one of the motors 4. Said decentralized control modules 10, 11 are in the form of frequency converters and adapted to convert direct current made available from the energy storage device 9 and/or the energy generating device 1 into a three-phase alternating current to thereby permit variable speed driving of the electric motors 4. The energy distribution system 3 comprises one further decentralized control module 12 in the form of an inverter that provides alternating current of constant frequency (in particular 50 cps or 60 cps) and constant voltage (in particular 230 V or 120 V) out of direct current. Said inverter 12 is used to feed energy also to other electric consumers such as a computer 13, a coffee machine 14 and an electrically operated air compressor 15 to fill diving cylinders. It goes without saying that further electric consumers not shown may be provided through which additional comfort and/or safety functions can be carried into effect.

Said facilities 13, 14, 15 connected to the inverter 12 constitute the on-board electric system of the vehicle. A transformer 16 is arranged between on-board system and inverter 12 which is an isolating transformer for electric isolation of the on-board system from the energy distribution system 3. Moreover, a coupler element 17 is connected to the inverter 12 via the isolating transformer 16. This coupler element 17 may be a plug, for instance, to connect the vehicle to a stationary land electric system. Upon connection to the land power system this inverter 12 that simultaneously serves as storage-charger unit permits to charge the energy storage unit 9 of the vehicle from ashore and to operate the electric consumers 13, 14, 15 of the on-board system on land current. The isolating transformer 16 provides electric isolation between the land power system and the energy storage unit 9.

A central control device 18 provided to coordinate the various functional components of the drive system comprises input means 19 for signal input by a user, output means 20 for information output to a user and a central control unit 21. The input means 19 may be in the form of switching elements, sliders or such like, for instance, while a screen, a loudspeaker or signal lamps may be used as output means. It is possible also to provide a combined input/output unit by providing a touch screen.

The central control unit 21 is data-technically coupled to the energy generating device 1, the energy storage device 2 and the energy distribution system 3. It serves to coordinate the generation, storage and distribution of electric energy aboard the vehicle and to tune the operational behavior of each of the various functional components. The central control unit 21 is for this purpose connected to the energy generating device 1 and the energy distribution system 3 via a first data bus 22. A second data bus 23 is provided for data-technical coupling of the central control unit 21 with the energy storage device 2. The central control unit 21 serves as a communication master in that case which is the only component that is authorized to give information to one of the data buses 22, 23 without demand. The energy generating device 1, the energy storage device 2 and the energy distribution system 3 are here subordinated bus members (slaves) which cannot send data via the data bus 22, 23 unless requested to do so by the central control unit 21.

The provision of said two data buses 22, 23 affords the advantage that the functional components essential to a safe and dependable performance of the safety-critical driving and navigating functions, namely the energy generating device 1 and the energy storage device 2, are enabled to communicate with the decentralized control modules 10, 11 assigned to the electric motors 4 via the first data bus 22 which is provided solely for this purpose while the second data bus 23 serves for networking less central functional components of the drive system.

Linked to the second data bus 23, for instance, are temperature sensors 24 which serve to monitor the temperature of the electric motors 4 and to send temperature data to the central control unit 21 via the data bus 23. Analog and/or digital interface modules 25 are provided to link said temperature sensors 24 to the second data bus 23 and to embed measured data from the sensors 24 into the communication protocol of the second data bus 23. Further sensors such as current and voltage sensors 26 are coupled to the second data bus 23 via interface modules 25 with a first current and voltage sensor 26 disposed between the energy generating device 1 and the energy storage device 2 and a second current and voltage sensor 26 between the energy storage device 2 and the energy distribution system 3. Since said two current and voltage sensors 26 are provided it is possible to draw conclusions as to the operating states of the energy storage device 2 and/or the charge condition of the energy storage unit 9 from the results of differential current and voltage measurements. The measured data from the current and voltage sensors 26 may be transmitted to the central control unit 21 and/or to a not-shown decentralized control module of the energy storage device 2 for evaluation purposes.

Non-local control parameters can be transferred from the central control unit 21 to at least one of the decentralized control modules 10, 11, 12 and/or local control parameters from the decentralized control modules 10, 11, 12 to the central control unit 21 for coordination of the operating behavior of all of the functional components of the drive system. Such control parameters may for instance be setpoint values, actual values or operating commands.

Moreover, further functional components of the drive system such as a control platform 27 may be coupled to the central control unit 21. Said control platform 27 serves for receiving command signals entered by the user in regard to speed and load distribution between the two electric motors 4.

The data bus 23 may also be used to activate the electric consumers 13, 14, 15 via one individual circuit module 28 each. This circuit module 28 may be of digital type and serve for ON/OFF control of the electric consumers 13, 14, 15, but of analog type also to separately influence the operating states of any of the electric consumers 13, 14, 15. A coolant pump for cooling the energy distribution system 3, for instance, may be cooled this way by substantially varying the coolant flow via the speed of the pump.

It is due to coordination of the operating behavior of the central functional components of the drive and data-technical coupling of the central control unit 21 with the decentralized control modules 10, 11, 12 of the energy generating device 1 and the energy storage device 2 that reactions are possible to predetermined operating states of the Diesel electric drive system in the absence of any manual intervention by the user.

In case of an inadmissibly exhaustive discharge of the energy storage unit 9 due to power consumption by the electric motors 4 the central control unit 21 may decide on its own to start the generator 7 via the combustion engine 6 such that electric power be made available by said generator 7 to charge the energy storage unit 9 and to thereby counteract any further exhaustive discharge of the storage unit.

When the electric motors 4 are operating under maximum load conditions, for instance, the central control unit 21 can make energy available both via the generator and the energy storage unit 9. Also can the supply of energy to other electric consumers 13, 14, 15 with lesser priority than the electric motors 4 be completely deactivated temporarily via the switching modules 28. It is imaginable in this conjunction that neither the generator 7 nor the energy storage unit 9 alone is capable of supplying the power needed for full-load operation of the electric motors 4.

When the temperature sensors 24 signalize that the temperature of the electric motors 4 is inadmissibly high, for instance, the central control unit 21 can be caused to reduce the driving power and/or to increase the cooling capacity.

In case of creeping discharge of the energy storage unit 9 due to continuous electric power consumption by operation of the electric consumers 13, 14, 15, however, it is possible to have said facilities automatically cut out via the switching mo-dules 28 and/or the energy storage unit 9 recharged by reactivating the energy generating device 1.

It is due to merging of sensor data, control parameters and operating states of the various functional modules in the central control unit 21 that condition monitoring and/or early error detection may be achieved solely by a merger of measured values and operating parameters from various functional components inside the central control unit 21. This central control unit 21 may for instance carry into effect a classical control or regulating pattern for driving the electric motors 4 under variable or fixed speed conditions. Said merging of operating data also permits to implement ship control in a fuzzy logic mode.

In the operational scenarios hereinbefore described by way of example the control unit is enabled due to networking of various functional components of the drive system to completely decide on its own as to which action is to be taken and to initiate the measures thus necessary. Alternatively, the central control unit 21 proposes corresponding measures to the user which are displayed via output means of the control equipment 20. The user may then decide on the respective measures to be taken for this purpose and gives commands to the central control unit 21 or the decentralized control module 10, 11, 12 via the input means 19. It is possible also for the user to centrally cut said further electric consumers on or off via the input means 19.

According to an alternative embodiment of the invention as per FIG. 2 the two decentralized control modules 10, 11 serve to drive one only electric motor 4. This electric motor 4 is of redundant type to ensure safe and dependable operation and has two windings to provide redundance of which the first one is activated via the first decentralized control module 10 and the second one via the second control module 11. This way it is possible for the electric motor 4 to keep operating, though possibly at reduced capacity, when one of the windings or one of said decentralized control modules 10, 11 fails.

Identical components and component functions are denoted by identical reference signs.

One only data bus 22 is provided for data-technical coupling of the central control unit 21 with the functional modules of the drive system to which bus all of the bus members hereinbefore described are linked. Provision of a second data bus has been renounced. Priorization of the individual bus members may be achieved via the bus protocol. Also it is possible to waive such priorization completely.

The energy generating device 1 has a decentralized control module 30 of its own which serves to control Diesel engine 6 and generator 7. This decentralized control module 30 is for this purpose connected to the central control unit 21 via the data bus 22 such that non-local control parameters can be transmitted from said central control unit 21 to the decentralized control module 30 and local control parameters from the decentralized control module 30 to the central control unit 21.

As an additional bus member there is a GPS sensor 31 arranged through which position signals can be received and passed on to the central control unit 21 via data bus 22. The central control unit 21 is adapted to process said position data for navigation or to pass corresponding information to the user via the output means 20.

Also, the central control unit 21 of the control device 18 is coupled with a radio module 32 by means of which external information can be received and transferred to downstream functional components. This way it is possible for instance by remote access to the system to read out errors or to apply software updates. Moreover can external data be received and transmitted from the control device 18 and/or downstream functional components. For instance can position or error information be sent to external receivers.

According to a not-shown alternative embodiment of the invention it is possible to allocate the various functional modules to two or more data buses 22, 23 in a virtually arbitrary manner. For example can the not-shown decentralized control module for the energy storage device 26 and/or the current and voltage sensors 26 communicate with the central control unit 26 via the first data bus 22. It is possible also to select the control platform 27 via the first data bus 22 rather than the second bus 23 and to provide an additional data bus. Provision of any of the data buses 22, 23 may be waived and instead a wireless network be arranged or star-shaped cabling of the central control 21 with the functional components of the drive system and/or onboard system be implemented.

1. A device for controlling a vehicle, wherein the vehicle has a drive system comprising an energy generating device with a combustion engine, a generator adapted to coact with said combustion engine for converting the mechanical energy produced inside said engine into electrical energy, and a rectifier for rectifying the energy made available by said generator; an energy storage device with an energy storage unit to store the energy made available by the generator for energy output as and how required; and an energy distribution system for distributing the energy made available by the energy generating and/or the energy storage device to at least one electric motor used to drive a propeller, as well as to other electric power consumers, wherein a central control device (18) with a central control unit (21) is provided which latter is data-technically coupled with the energy generating device (1), the energy storage device (2) and the energy distribution system (3) to coordinate energy generation, storage and distribution, and that the central control device (18) has output means (20) for display of information to a user and/or input means (19) for entry of signals by the user.

2. The device according to claim 1, wherein a data bus (22, 23) is provided for data-technical coupling of the central control unit (21) with at least one of the energy generating device (1), the energy storage device (2) and the energy distribution system (3).

3. The device according to claim 1, wherein the central control unit (21) is coupled to a decentralized control module (30) of the energy generating device (1) and/or to a decentralized control module (30) of the energy storage device (2) and/or with a decentralized control module (10, 11, 12) of the energy distribution system such that non-local control parameters can be transmitted from the central control unit (21) to at least one of the decentralized control modules (10, 11, 12, 30) and/or local control parameters from said at least one decentralized control module (10, 11, 12, 30) to the central control unit (21)

4. The device according to claim 1, wherein operating parameters of at least one of the energy generating device (1), the energy storage device (2), the energy distribution system (3), of the at least one electric motor (4), of further consumers (13, 14, 15) is collected by at least one sensor (14, 26) which is connected to the data bus (22, 23) via an analog and/or digital interface module (25) for transmission of operating parameters to the central control unit (21) and/or to one of the decentralized control modules (10, 11, 12, 30).

5. The device according to claim 1, wherein measuring means (26) are arranged between the energy generating device (1) and the energy storage device (2) on the one hand and between the energy storage device (2) and the energy distribution system (3) on the other hand for assessing operating states of the energy storage device (2) via differential current and voltage measurement and that said measuring means (26) are connected to the central control unit (21) and/or the decentralized control module (10, 11, 12, 30) of the energy storage device (2).

6. The device according to claim 1, wherein at least one electric facility serving as a further consumer (13, 14, 15) is connected to the energy distribution system (3) to supply electric energy thereto and that a switching module (28) connected to the central control unit (21) and/or to one of the decentralized control modules (10, 11, 12, 30) is assigned to said facility (13, 14, 15) via the data bus (22, 23) such that said facility (13, 14, 15) can be activated and/or deactivated from the central control unit (21) and/or one of the decentralized control modules (19, 11, 12, 30) via said control module (28).

7. The device according to claim 1, wherein the energy distribution system (3) comprises at least one frequency converter (10, 11) as decentralized control module (10, 11) for variable-speed driving of the at least one electric motor (4) and/or at least one inverter (12) as further decentralized control module (30) for rectifying the DC voltage made available by the energy generating device (1) and/or the energy storage device (2).

8. The device according to claim 1, wherein an isolating transformer (16) is assigned to the energy distribution system (3) and arranged between the energy distribution system (3) and a coupler element (17) for electro-mechanical connection of said distribution system (3) to a stationary land power supply system wherein the energy distribution system (3) comprises as storage-charger unit an inverter (12) which is in electric connection with the coupler element via said transformer (17) for charging the energy storage unit (9) with land power.

9. The device according to claim 1, wherein the central control unit (21) is connected to the energy generating device (1) and/or the energy storage device (2) via a first data bus (22, 23) and to the energy storage device (2) and/or further consumers (13, 14, 15) via a second data bus (23).

10. The device according to claim 1, wherein the central control device (18) is coupled with a radio module (32) for transmitting data from an external transmitter to the central control device (18) and/or for sending data from the central control unit (18) to an external receiver.

11. A watercraft with a drive system comprising
an energy generating device with a combustion engine, a generator adapted to coact with said combustion engine for converting the mechanical energy produced inside said engine into electrical energy, and a rectifier for rectifying the energy made available by said generator;
an energy storage device with an energy storage unit to store the energy made available by the generator for energy output as and how required; and
an energy distribution system for distributing the energy made available by the energy generating and/or the energy storage device to at least one electric motor used to drive a propeller, as well as to other electric power consumers, and
a central control device (18) with a central control unit (21), which central control unit (21) is data-technically coupled with the energy generating device (1), the energy storage device (2) and the energy distribution system (3) to coordinate energy generation, storage and distribution,
wherein the central control device (18) has output means (20) for display of information to a user and/or input means (19) for entry of signals by the user.
